(19) United States
(12) Patent Application Publication
(10) Pub. No.: US 2013/0215858 A1
(43) Pub. Date: Aug. 22, 2013

(54) METHOD AND DEVICE FOR TRANSMITTING UPLINK CONTROL INFORMATION WHEN RETRANSMITTING UPLINK DATA IN WIRELESS ACCESS SYSTEM

(71) Applicants: Jiwoong Jang, Anyang (KR); Jaehoon Chung, Anyang (KR); Seunghee Han, Anyang (KR)

(72) Inventors: Jiwoong Jang, Anyang (KR); Jaehoon Chung, Anyang (KR); Seunghee Han, Anyang (KR)

(73) Assignee: LG ELECTRONICS INC., Seoul (KR)

(21) Appl. No.: 13/878,959

(22) PCT Filed: Oct. 10, 2011
(86) PCT No.: PCT/KR11/07480

§ 371 Date: Apr. 11, 2013

Related U.S. Application Data
(60) Provisional application No. 61/391,684, filed on Oct. 11, 2010.

(51) Int. Cl. H04W 72/04

(52) U.S. Cl. CPC H04W 72/0413
USPC 370/329

(57) ABSTRACT

The present invention relates to a wireless access system and further relates to various methods for transmitting uplink control information when retransmitting uplink data in a carrier aggregation environment (i.e., multiple component carrier environment). The method for transmitting uplink control information (UCI) in the wireless access system, according to one embodiment of the present invention, comprises the following steps: transmitting uplink data to a base station; receiving a non-acknowledgement (NACK) signal of the uplink data from the base station; selecting a transport block for transmitting UCI when retransmitting the uplink data according to the NACK signal; and retransmitting the uplink data including the UCI, wherein a user equipment can transmit the UCI to the base station using the selected transport block.

### TECHNICAL FIELD

The present invention relates to a wireless access system, and more particularly, to a method for transmitting uplink control information in a carrier aggregation environment (that is, multi-component carrier environment). More particularly, the present invention relates to a method and devices for transmitting uplink control information if uplink data are retransmitted.

### BACKGROUND ART

Hereinafter, a general multiple input multiple out (MIMO) system will be described in brief.

Recently, the MIMO system has received much attention as the broadband wireless mobile communication technology. The MIMO system may improve spectral efficiency in proportional to the number of antennas, wherein the spectral efficiency could not be obtained in a single input single output (SISO) system.

The MIMO technique means a multi-antenna technique where communication is performed at high speed using a plurality of antennas. The MIMO technique may be divided into a spatial multiplexing scheme and a spatial diversity scheme depending on same data transmission.

The spatial multiplexing scheme is to transmit different data through a plurality of transmitting and receiving antennas at the same time. Namely, a transmitter transmits different data through each transmitting antenna, and a receiver improves a transmission rate as much as the number of transmitting antennas by classifying transmission data through proper interference removal and signal processing.

The spatial diversity scheme is to obtain transmission diversity by transmitting same data through multiple transmitting antennas. Namely, the spatial diversity scheme is a kind of a space time channel coding scheme. The spatial diversity scheme may maximize transmission diversity gain (throughput gain) by transmitting same data from multiple transmitting antennas. However, the spatial diversity scheme is intended not to improve a transmission rate but to improve reliability of transmission in accordance with diversity gain.

Also, the MIMO technique may be divided into an open loop mode (for example, BLAST, STTC, etc) and a closed loop mode (for example, TxAA, etc.) in accordance with feedback of channel information from the receiver to the transmitter.

Hereinafter, a carrier of a system according to the related art will be described. In a general wireless access system, only a single carrier may be considered even though bandwidths between an uplink and a downlink are set up to be different from each other. For example, on the basis of a single carrier, a wireless communication system may be provided, in which the number of carriers constituting the uplink and the number of carriers constituting the downlink may be 1, respectively, and a bandwidth of the uplink is symmetrical to that of the downlink.

In the International Telecommunication Union (ITU), it is required that the candidate technology of the IMT-Advanced should support an extended bandwidth as compared with the wireless communication system according to the related art. However, except for some areas of the world, it is difficult to allocate frequencies of wide bandwidths. Therefore, as a technique for effectively using fragmented small bands, a carrier aggregation (CA) (bandwidth aggregation or multi-cell or spectrum aggregation) technique is being developed to obtain the same effect as when a band of a logically wide bandwidth is used by physically aggregating a plurality of bands in a frequency domain.

The carrier aggregation is introduced to support increased data throughput, prevent the cost from being increased by a wideband RF device, and ensure compatibility with the existing system. The carrier aggregation refers to a technique of enabling data exchange between a user equipment and a base station through a plurality of groups of carriers of a bandwidth unit defined in the existing wireless communication system (LTE system in case of LTE-A system, or IEEE 802.16e system in case of IEE 802.16m system).

In this case, the carriers of a bandwidth unit defined in the existing wireless communication system may be referred to as component carriers (CC). For example, the carrier aggregation technique may include a technique for supporting a system bandwidth of maximum 100 MHz by using maximum five component carriers even if one component carrier supports a bandwidth of 5 MHz, 10 MHz or 20 MHz.

If the carrier aggregation technique is used, data may simultaneously be transmitted and received through several uplink/downlink component carriers. Accordingly, the user equipment may monitor and measure all the component carriers.

### DISCLOSURE

### Technical Problem

3GPP LTE (3rd Generation Partnership Project Long Term Evolution; Rel-8 or Rel-9) system (hereinafter, referred to as ‘LTE system’) uses a multi-carrier modulation (MCM) scheme that uses a single component carrier (CC) by dividing the single component carrier into several bands. However, in a 3GPP LTE-Advanced system (hereinafter, referred to as ‘LTE-A system’), a method such as carrier aggregation that uses one or more component carriers through aggregation may be used to support a system bandwidth broader than that of the LTE system. Carrier aggregation may be replaced with carrier matching, multi-component carrier (multi-CC) environment or multi-carrier environment.

The LTE system describes that a user equipment transmits and/or retransmits uplink control information to one transport block (TB) having one layer. However, the LTE-A system considers that uplink control information is transmitted in a carrier aggregation (CA) environment. In particular, in case of a single user MIMO (SU-MIMO) under the carrier aggregation environment, since a user equipment and/or base station transmits and receives two or more data streams by using two or more transport blocks (TBs), a new method different from the existing method for transmitting and/or retransmitting uplink control information will be required.

An object of the present invention devised to solve the conventional problem is to provide various methods for efficiently transmitting uplink control information in a multi-carrier environment (or carrier aggregation environment).

Another object of the present invention is to provide various methods for selecting a transport block (TB), which transmits uplink control information, when uplink data are transmitted in the SU-MIMO environment.

Other object of the present invention is to provide a transmission device and/or a reception device, which supports the aforementioned methods.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

The present invention discloses various methods and devices for transmitting uplink control information in a carrier aggregation environment (that is, multi-component carrier environment).

In one aspect of the present invention, a method for transmitting uplink control information (UCI) from a user equipment in a wireless access system comprises the steps of transmitting uplink data to a base station; receiving non-acknowledgement (NACK) signal for the uplink data from the base station; selecting a transport block for transmitting the UCI, during retransmission of the uplink data in accordance with the NACK signal; and retransmitting uplink data including the UCI, wherein the user equipment transmits the UCI to the base station by using the selected transport block.

In another aspect of the present invention, a method for receiving uplink control information (UCI) by a base station in a wireless access system comprises the steps of receiving uplink data from a user equipment; transmitting a non-acknowledgement (NACK) signal for the uplink data to the user equipment; and receiving the uplink data retransmitted in accordance with the NACK signal, wherein the UCI is included in the retransmitted uplink data, and a transport block, which includes the UCI, is selected considering one or more of the number of retransmission times, a modulation and coding scheme (MCS) level, and a transport block size.

In the aforementioned aspects of the present invention, if a first transport block is used to transmit new uplink data and a second transport block is used to retransmit the uplink data, the selected transport block is preferably the second transport block.

Also, if one or more transport blocks are used to retransmit the uplink data, the selected transport block is preferably the transport block having the greater number of retransmission times.

Also, if one or more transport blocks are used to retransmit the uplink data, the selected transport block is preferably the transport block having a high modulation and coding scheme (MCS) level.

Also, if one or more transport blocks are used to retransmit the uplink data, the selected transport block is preferably the transport block having the greatest transport block size.

In the embodiments of the present invention, the UCI may be a channel quality indicator (CQI).

The aspects of the present invention are only a part of the preferred embodiments of the present invention, and various embodiments based on technical features of the present invention may be devised and understood by the person with ordinary skill in the art based on the detailed description of the present invention.

### Advantageous Effects

According to the embodiments of the present invention, the following advantages may be obtained.

First of all, the user equipment may efficiently transmit uplink control information when retransmitting uplink data in a multi-carrier environment (or carrier aggregation environment).

Second, the user equipment may efficiently transmit uplink control information by multiplexing uplink control information into the uplink data.

Third, if uplink control information is multiplexed in the SU-MIMO environment, the user equipment may retransmit data by selecting the transport block (TB) for transmitting uplink control information, in consideration of retransmission data.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating physical channels used in a 3GPP system and a general method for transmitting a signal using the physical channels;

FIG. 2 is a diagram illustrating a structure of a user equipment and a signal processing procedure for transmitting an uplink signal from the user equipment;

FIG. 3 is a diagram illustrating a structure of a base station and a signal processing procedure for transmitting a downlink signal from the base station;

FIG. 4 is a diagram illustrating an SC-FDMA system and an OFDMA system;

FIG. 5 is a diagram illustrating a signal mapping system on a frequency domain for satisfying single carrier properties;

FIG. 6 is a block diagram illustrating transmission processing of a reference signal (RS) for demodulation of a transport signal based on the SC-FDMA system;

FIG. 7 is a diagram illustrating a symbol location into which a reference signal (RS) is mapped in a subframe structure based on the SC-FDMA system;

FIG. 8 is a diagram illustrating a signal processing procedure in which DFT process output samples are mapped into a single carrier in a clustered SC-FDMA;

FIG. 9 and FIG. 10 are diagrams illustrating a signal processing procedure in which DFT process output samples are mapped into multi-carriers in a clustered SC-FDMA;

FIG. 11 is a diagram illustrating a signal processing procedure in segment SC-FDMA;

FIG. 12 is a diagram illustrating a structure of an uplink subframe that may be used in the embodiments of the present invention;

FIG. 13 is a diagram illustrating a procedure of processing UL-SCH data and uplink control information that may be used in the embodiments of the present invention;

FIG. 14 is a diagram illustrating a method of multiplexing control information and UL-SCH data on a PUSCH;

FIG. 15 is a diagram illustrating multiplexing of control information and UL-SCH data in a multiple input multiple output (MIMO) system;

FIG. 16 and FIG. 17 are diagrams illustrating a method of multiplexing a plurality of UL-SCH transport blocks included in a user equipment and uplink control information in the user equipment and transmitting the multiplexed data in accordance with one embodiment of the present invention;

FIG. 18 is a diagram illustrating a method for transmitting uplink control information during uplink data transmission in accordance with one embodiment of the present invention; and

FIG. 19 is a diagram illustrating a base station and a user equipment through which the embodiments of the present invention described with reference to FIG. 1 to FIG. 18 may be carried out.

### BEST MODE FOR CARRYING OUT THE INVENTION

The present invention relates to a wireless access system, and provides various methods for transmitting uplink control information in a carrier aggregation environment (that is, multi-component carrier environment). Also, the embodiments of the present invention provide a method and devices for transmitting uplink control information when uplink data are retransmitted. in the SU-MIMO environment.

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

In the description of drawings, procedures or steps that may make the subject matter of the present invention obscure will not be disclosed. Also, procedures or steps that may be understood by the person with ordinary skill in the art will not be disclosed.

In this specification, the embodiments of the present invention have been described based on the data transmission and reception between a base station and a mobile station. In this case, the base station means a terminal node of a network, which performs direct communication with the mobile station. A specific operation which has been described as being performed by the base station may be performed by an upper node of the base station as the case may be.

In other words, it will be apparent that various operations performed for communication with the mobile station in the network which includes a plurality of network nodes along with the base station may be performed by the base station or network nodes other than the base station. At this time, the base station (BS) may be replaced with terms such as a fixed station, Node B, eNode B (eNB), an advanced base station (ABS), and an access point (AP).

Also, a terminal may be replaced with terms such as a user equipment (UE), a mobile station (MS), a subscriber station (SS), a mobile subscriber station (MSS), a mobile terminal, or an advanced mobile station (AMS).

Furthermore, a transmitting side means a fixed or mobile node that transmits data services or voice services while a receiving side means a fixed or mobile node that receives data services or voice services. Accordingly, in an uplink, the mobile station could be the transmitting side while the base station could be the receiving side. Likewise, in a downlink, the mobile station could be the receiving side while the base station could be the transmitting side.

The embodiments of the present invention may be supported by standard documents disclosed in at least one of wireless access systems, i.e., IEEE 802 system, 3GPP system, 3GPP LTE system, and 3GPP2 system. Particularly, the embodiments of the present invention may be supported by one or more of documents of 3GPP TS 36.211, 3GPP TS 36.212, 3GPP TS 36.213, and 3GPP TS 36.321. Namely, among the embodiments of the present invention, steps or parts which are not described to clarify the technical features of the present invention may be supported by the above standard documents. Also, all terminologies disclosed herein may be described by the above standard documents.

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

Specific terminologies hereinafter used in the embodiments of the present invention are provided to assist understanding of the present invention, and various modifications may be made in the specific terminologies within the range that they do not depart from technical spirits of the present invention.

The following technology may be used for various wireless access systems such as CDMA (code division multiple access), FDMA (frequency division multiple access), TDMA (time division multiple access), OFDMA (orthogonal frequency division multiple access), and SC-FDMA (single carrier frequency division multiple access).

The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved UTRA (E-UTRA).

The UTRA is a part of a universal mobile telecommunications system (UMTS). A 3^{rd} generation partnership project long term evolution (3GPP LTE) communication system is a part of an evolved UMTS (E-UMTS) that uses E-UTRA, and uses OFDMA in a downlink while uses SC-FDMA in an uplink. LTE-advanced (LTE-A) is an evolved version of the 3GPP LTE system. Although the embodiments of the present invention will be described based on the 3GPP LTE/LTE-A to clarify description of technical features according to the present invention, it is to be understood that the embodiments of the present invention may be applied to IEEE 802.16e system.

1.3GPP LTE/LTE-A System

In a wireless communication system, a user equipment receives information from a base station through a downlink (DL), and also transmits information to the base station through an uplink (UL). Examples of information transmitted from or received in the base station and the user equipment include data and various kinds of control information, and various physical channels exist depending on a type and usage of the information transmitted from or received in the base station and the user equipment.

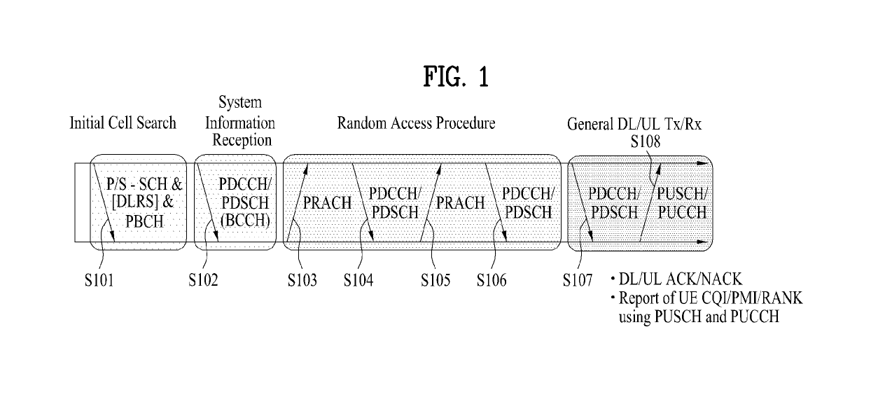

FIG. 1 is a diagram illustrating physical channels used in a 3GPP LTE system and a general method for transmitting a signal using the physical channels.

The user equipment performs initial cell search such as synchronizing with the base station when it newly enters a cell or the power is turned on at step S101. To this end, the user equipment synchronizes with the base station by receiving a primary synchronization channel (P-SCH) and a secondary synchronization channel (S-SCH) from the base station, and acquires information such as cell ID, etc.

Afterwards, the user equipment may acquire broadcast information within the cell by receiving a physical broadcast channel (PBCH) from the base station. Meanwhile, the user equipment may identify a downlink channel status by receiving a downlink reference signal (DL RS) at the initial cell search step.

The user equipment which has finished the initial cell search may acquire more detailed system information by receiving a physical downlink shared channel (PDSCH) in accordance with a physical downlink control channel (PDCCH) and information carried in the PDCCH at step S102.

Afterwards, the user equipment may perform a random access procedure (RACH) such as steps S103 to S106 to complete access to the base station. To this end, the user equipment may transmit a preamble through a physical random access channel (PRACH) (S103), and may receive a response message to the preamble through the PDCCH and the PDSCH corresponding to the PDCCH (S104). In case of a contention based RACH, the user equipment may perform a contention resolution procedure such as transmission (S105) of additional physical random access channel and reception (S106) of the physical downlink control channel and the physical downlink shared channel corresponding to the physical downlink control channel.

The user equipment which has performed the aforementioned steps may receive the physical downlink control channel (PDCCH)/physical downlink shared channel (PDSCH) (S107) and transmit a physical uplink shared channel (PUSCH) and a physical uplink control channel (PUCCH) (S108), as a general procedure of transmitting uplink/downlink signals.

Control information transmitted from the user equipment to the base station will be referred to as uplink control information (UCI). The UCI includes HARQ ACK/NACK (Hybrid Automatic Repeat and reQuest Acknowledgement/Negative-ACK), SR (Scheduling Request), CQI (Channel Quality Information), a PMI (Precoding Matrix Indicator), RI (Rank Indication), etc.

Although the UCI is periodically transmitted through the PUCCH in the LTE system, it may be transmitted through the PUSCH if control information and traffic data should be transmitted at the same time. Also, the user equipment may non-periodically transmit the UCI through the PUSCH in accordance with request/command of the network.

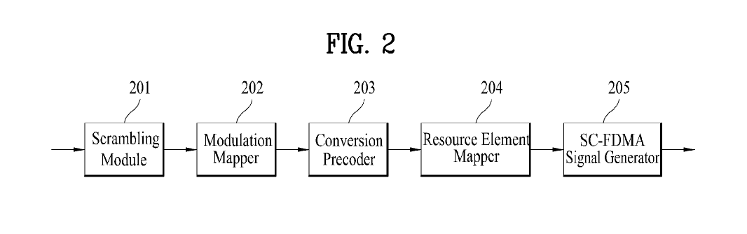

FIG. 2 is a diagram illustrating a structure of a user equipment and a signal processing procedure for transmitting an uplink signal from the user equipment.

A scrambling module 210 of a user equipment may scramble transmitting signals by using a user equipment specific scrambling signal to transmit an uplink signal. The scrambled signals are input to a modulation mapper 220 and are modulated into complex symbols by a binary phase shift keying (BPSK) mode, a quadrature phase shift keying (QPSK) mode, or a 16 quadrature amplitude modulation (QAM)/64QAM mode depending on types of the transmitting signals and/or the channel status. Afterwards, the modulated complex symbols are processed by a conversion precoder 230 and then input to a resource element mapper 240. The resource element mapper 240 may map the complex symbols into time-frequency resource elements. In this way, the processed signals may be transmitted to the base station through an antenna after passing through an SC-FDMA signal generator 250.

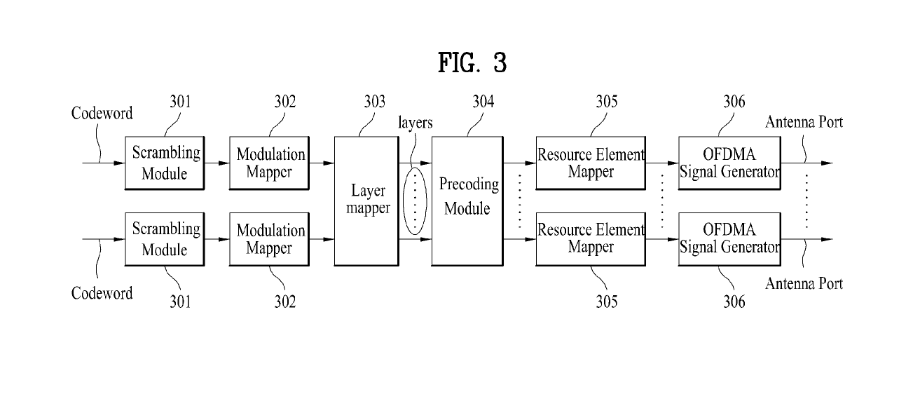

FIG. 3 is a diagram illustrating a structure of a base station and a signal processing procedure for transmitting a downlink signal from the base station.

In the 3GPP LTE system, the base station may transmit one or more codewords to the downlink. The codewords may be processed as complex symbols through a scrambling module 301 and a modulation mapper 302 in the same manner as the uplink of FIG. 2. Afterwards, the complex symbols are mapped into a plurality of layers by a layer mapper 303, wherein each layer may be multiplied by a predetermined precoding matrix selected by a precoding module 304 depending on the channel status and then may be allocated to each transmitting antenna. The transmitting signals per antenna, which are processed as above, are mapped into time-frequency resource elements by a resource element mapper 305. Afterwards, the processed signals may be transmitted through each antenna after passing through an OFDM signal generator 306.

If the user equipment transmits a signal to the uplink in the wireless communication system, a peak-to-average-ratio (PAPR) ratio may cause a problem as compared with that the base station transmits a signal to the downlink. Accordingly, as described with reference to FIG. 2 and FIG. 3, SC-FDMA (Single Carrier-Frequency Division Multiple Access) system is used for uplink signal transmission unlike OFDMA system used for downlink signal transmission.

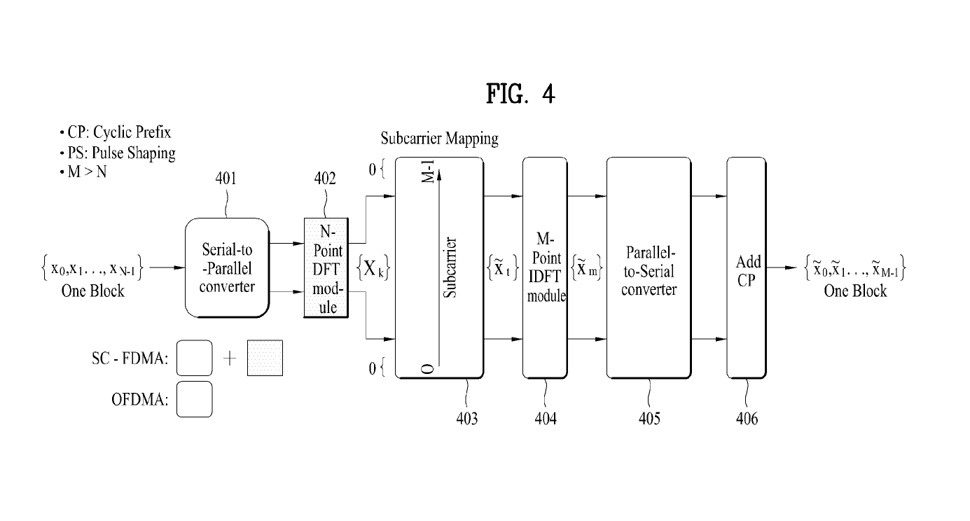

FIG. 4 is a diagram illustrating a structure of a user equipment and an SC-FDMA system and an OFDMA system.

The 3GPP system (e.g., LTE system) adopts OFDMA on the downlink and adopts SC-FDMA on the uplink. Referring to FIG. 4, the user equipment for uplink signal transmission is identical with the base station for downlink signal transmission in that they respectively include a serial-to-parallel converter 401, a subcarrier mapper 403, an M-point IDFT module 404, and a cyclic prefix (CP) addition module 406.

However, the user equipment for signal transmission based on the SC-FDMA system further includes a parallel-to-serial converter 405 and an N-point DFT module 402. The N-point DFT module 402 offsets IDFT processing effect of the M-point IDFT module 404 as much as a predetermined portion, whereby the transmitting signals have single carrier properties.

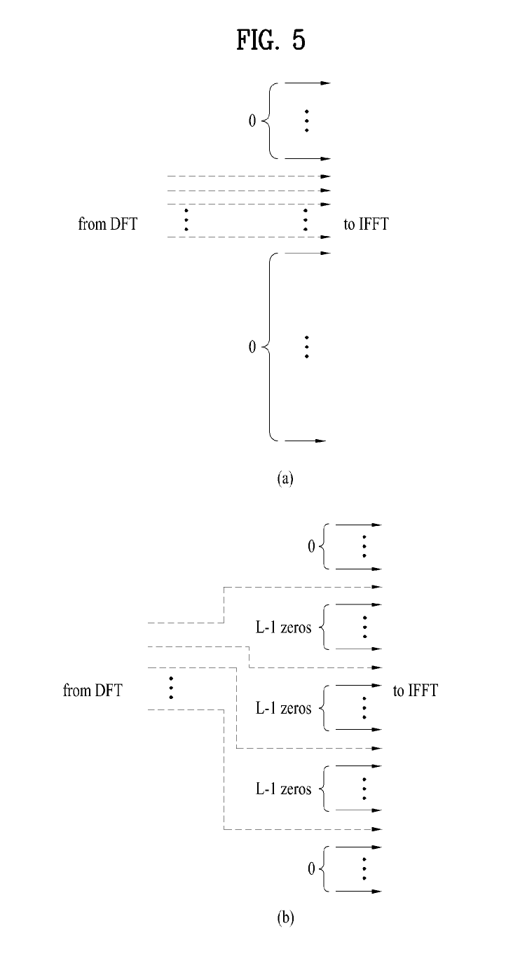

FIG. 5 is a diagram illustrating a signal mapping system on a frequency domain for satisfying single carrier properties in the frequency domain.

FIG. 5(a) illustrates a localized mapping system, and FIG. 5(b) illustrates a distributed mapping system. In this case, a clustered SC-FDMA which is a corrected type of SC-FDMA divides DFT process output samples into sub-groups during a subcarrier mapping procedure, and maps the sub-groups into the frequency domain (or subcarrier domain) discontinuously.

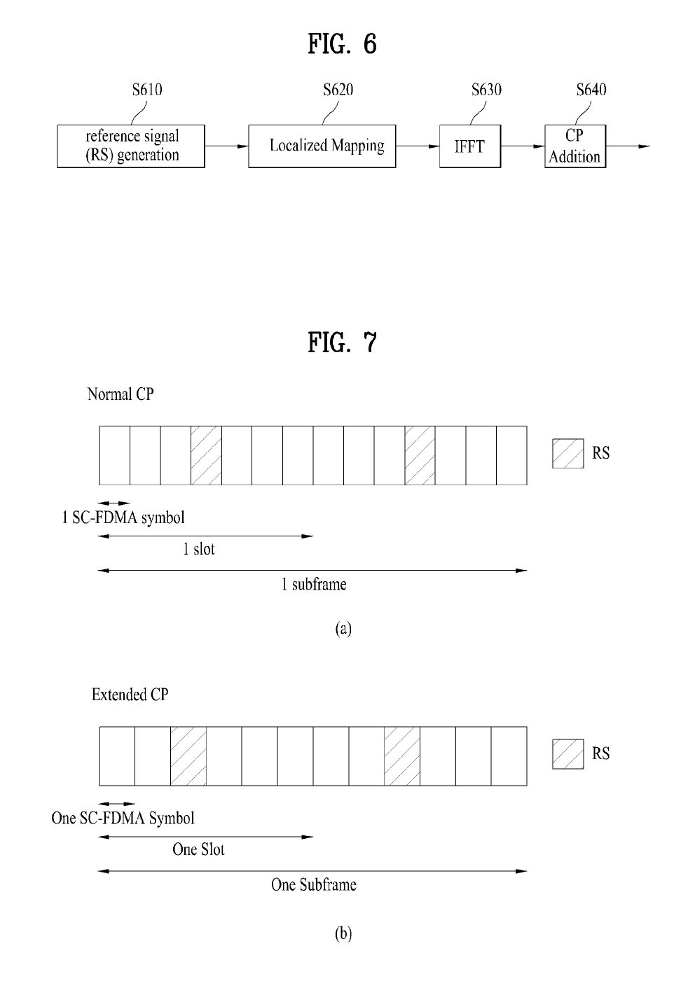

FIG. 6 is a block diagram illustrating transmission processing of a reference signal (RS) for demodulation of a transport signal based on the SC-FDMA system.

According to definition of the LTE standard (for example, 3GPP release 8), data are transmitted in such a manner that a signal generated in the time domain is converted into a frequency domain signal through DFT processing and then subjected to IFFT processing after subcarrier mapping (see FIG. 4), whereas the reference signal RS is transmitted in such a manner that a signal is generated in the frequency domain without DFT processing (S610), is mapped onto the subcarrier (S620), is subjected to IFFT processing (s630), and is transmitted through CP addition (S640).

FIG. 7 is a diagram illustrating a symbol location into which a reference signal (RS) is mapped in a subframe structure based on the SC-FDMA system.

FIG. 7(a) illustrates that the RS is located at the fourth SC-FDMA symbol of each of two slots in one subframe in case of a normal CP. FIG. 7(b) illustrates that the RS is located at the third SC-FDMA symbol of each of two slots in one subframe in case of an extended CP.

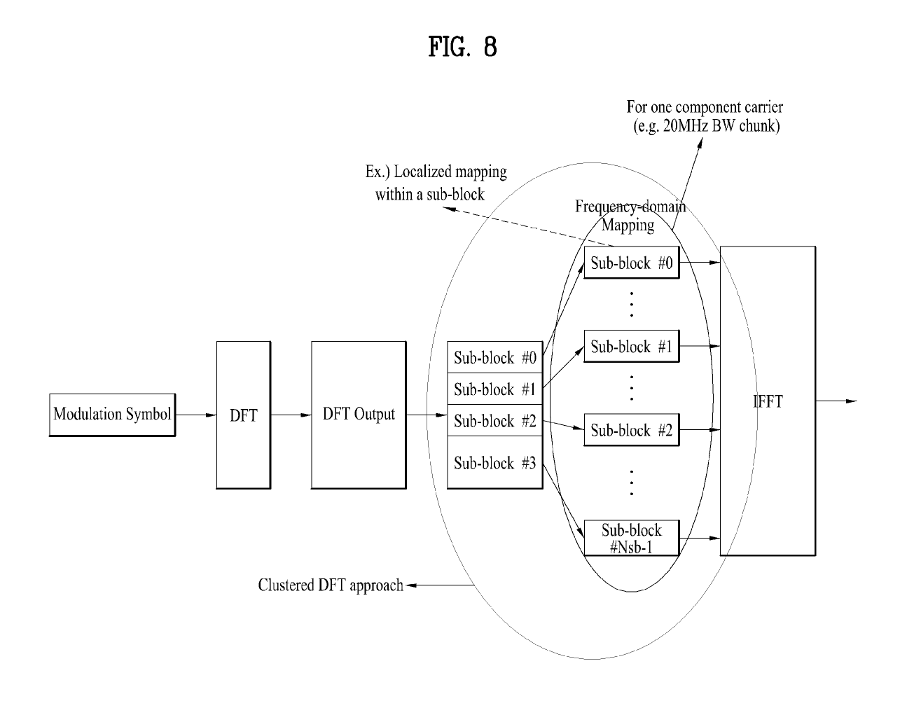

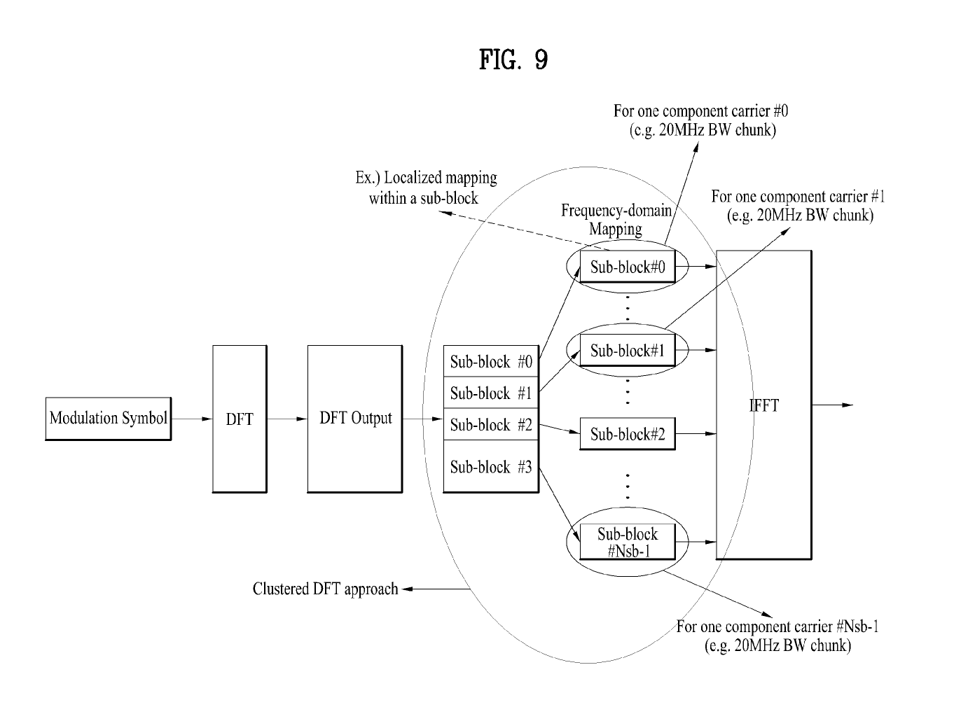

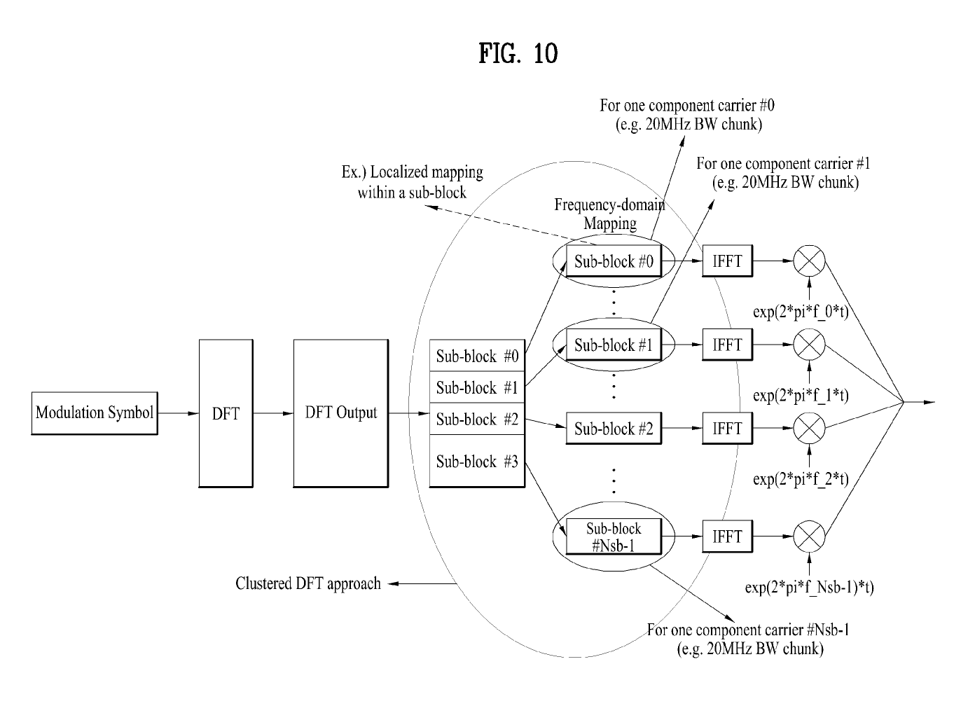

FIG. 8 is a diagram illustrating a signal processing procedure in which DFT process output samples are mapped into a single carrier in a clustered SC-FDMA. Also, FIG. 9 and FIG. 10 are diagrams illustrating a signal processing procedure in which DFT process output samples are mapped into multi-carriers in a clustered SC-FDMA.

FIG. 8 illustrates an example that clustered SC-FDMA is used for intra-carrier, and FIG. 9 and FIG. 10 illustrate examples that clustered SC-FDMA is used for inter-carrier. Also, in FIG. 9, a signal is generated through a single IFFT block if subcarrier spacing is aligned between adjacent component carriers in a state that contiguous component carriers are allocated in a frequency domain. In FIG. 10, a signal is generated through a plurality of IFFT blocks in a state that non-contiguous component carriers are allocated in a frequency domain.

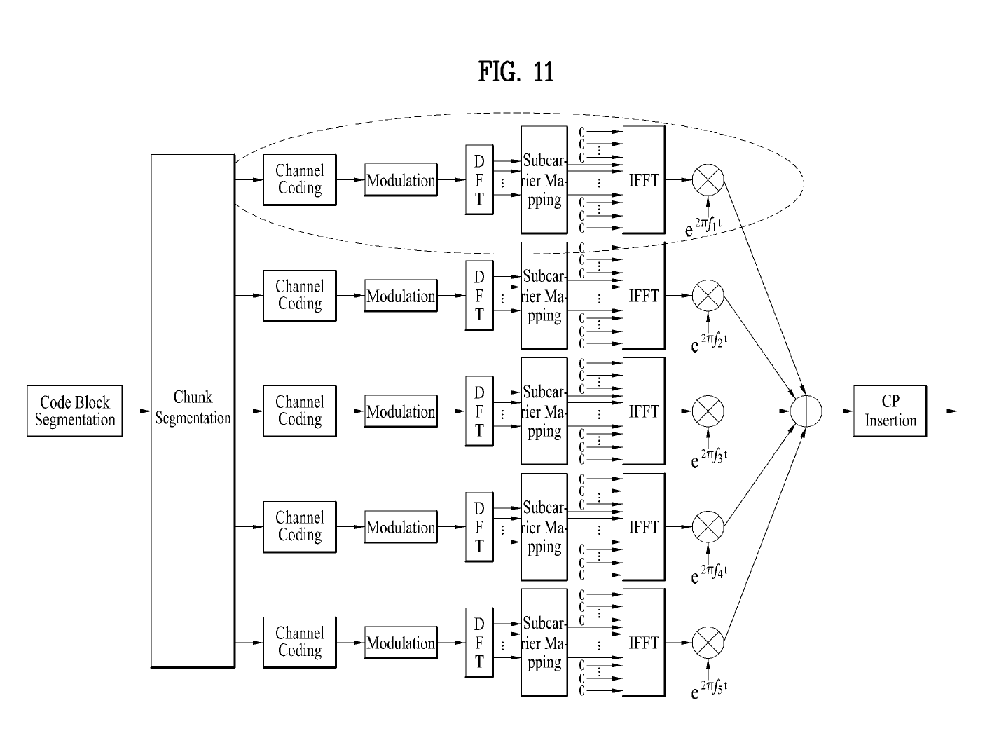

FIG. 11 is a diagram illustrating a signal processing procedure in segment SC-FDMA.

As a number of IFFTs equivalent to a random number of DFTs are used, DFT and IFFT have one-to-one correspondence relation, whereby DFT spreading of the existing SC-FDMA and frequency subcarrier mapping of IFFT are extended. In this case, NxSC-FDMA or NxDFT-s-OFDMA may be expressed. In this specification, NxSC-FDMA or NxDFT-s-OFDMA may be referred to as segmented SC-FDMA. Referring to FIG. 11, the segment SC-FDMA system performs DFT process in a group unit by grouping all time domain modulation symbols into N groups (N is an integer greater than 1) so as to relieve a condition of single carrier properties.

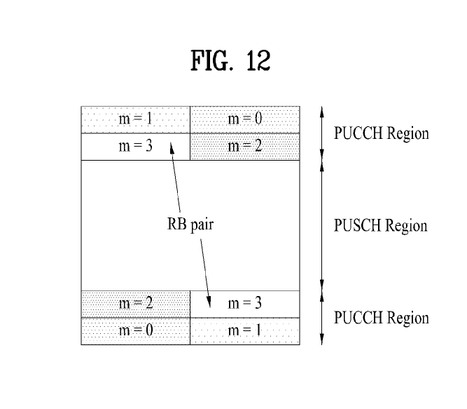

FIG. 12 is a diagram illustrating a structure of an uplink subframe that may be used in the embodiments of the present invention.

Referring to FIG. 12, the uplink subframe includes a plurality of slots (for example, two). Each slot may include a plurality of SC-FDMA symbols, wherein the number of SC-FDMA symbols included in each slot is varied depending on a cyclic prefix (CP) length. For example, in case of a normal CP, the slot may include seven SC-FDMA symbols.

The uplink subframe is divided into a data region and a control region. The data region is the region where a PUSCH is transmitted and received, and is used to transmit an uplink data signal such as voice. The control region is the region where a PUCCH signal is transmitted and received, and is used to transmit uplink control information.

The PUCCH includes RB pairs (for example, m=0, 1, 2, 3) located at both ends of the data region on a frequency axis. Also, the PUCCH includes RB pairs located at opposite ends on the frequency axis (for example, frequency mirrored RB pairs), and performs hopping on the border of the slots. The uplink control information (UCI) includes HARQ ACK/NACK, CQI, PMI, and RI.

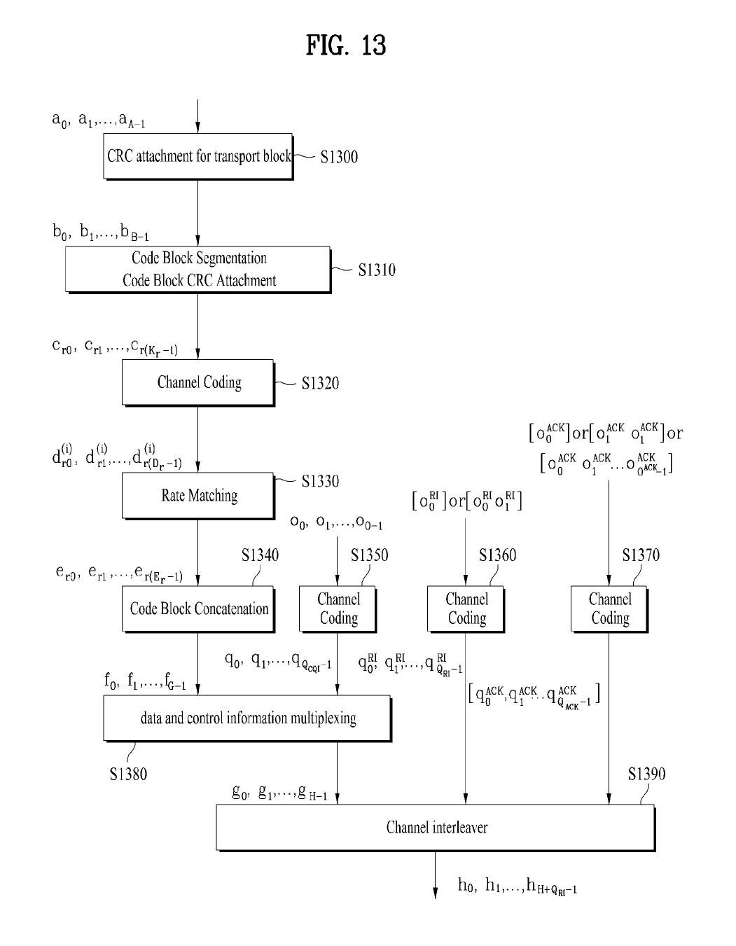

FIG. 13 is a diagram illustrating a procedure of processing UL-SCH data and uplink control information, which may be used in the embodiments of the present invention.

Referring to FIG. 13, error detection is provided to a UL-SCH transport block through cyclic redundancy check (CRC) attachment (S1300).

A full transport block is used to calculate CRC parity bits. Bits of the transport block are a₀, a₁, a₂, a₃, . . . , a_{A-1}. The parity bits are p₀, p₁, p₂, p₃, . . . , p_{L-1}. In this case, the size of the transport block is A, and the number of parity bits is L=24.

After the transport block CRC attachment, code block segmentation and code block CRC attachment are performed (S1310). Bit inputs for code block segmentation are b₀, b₁, b₂, b₃, . . . , b_{B-1}. At this time, B is the number of bits of the transport block (including CRC). Bits after code block segmentation are Cᵣ₀, cᵣ₁, cᵣ₂, cᵣ₃, . . . , c_{r(K}_{ᵣ}₋₁₎. In this case, ‘r’ is a code block number (r=0, 1, . . . , C−1), and ‘Kr’ is the number of bits for the code block r. Also, C represents a total number of code blocks.

Channel coding is performed after code block segmentation and code block CRC (S1320). Bits after channel coding are dᵣ₀⁽ⁱ⁾, dᵣ₁⁽ⁱ⁾, dᵣ₂⁽ⁱ⁾, dᵣ₃⁽ⁱ⁾, . . . , d_{r(D}_{ᵣ}₋₁₎. In this case, i=0, 1, 2, and ‘Dᵣ’ represents the number of bits of the ith coded streams for the code block ‘r’ (that is, Dᵣ=Kᵣ+4). ‘r’ represents the code block number (r=0, 1, . . . , C−1), and Kr represents the number of bits of the code block ‘r’. ‘C’ represents a total number of code blocks. Turbo coding may be used for channel coding.

Rate matching is performed after channel coding (S1330). Bits after rate matching are eᵣ₀, eᵣ₁, eᵣ₂, eᵣ₃, . . . , e_{r(E}_{ᵣ}₋₁₎. Eᵣ is the number of rate matched bits for the rth code block. ‘r=0, 1, . . . , C−1, and ‘C’ represents a total number of code blocks.

Code block connection is performed after rate matching (S1340). Bits after code block connection are f₀, f₁, f₂, f₃, . . . , f_{G-1}. G represents a total number of coded bits for transmission. When control information is multiplexed with UL-SCH transmission, bits used for control information transmission is not included in G. f₀, f₁, f₂, f₃, . . . , f_{G-1} corresponds to UL-SCH codewords.

In case of uplink control information, channel coding of channel quality information (CQI and/or PMI), RI and HARQ-ACK is performed independently (S1350, S1360, and S1370). Channel coding of the UCI is performed on the basis of the number of coded symbols for each of control information. For example, the coded symbols may be used for rate matching of coded control information. The number of coded symbols corresponds to the number of modulated symbols, the number of REs, etc. in the later process.

Channel coding of channel quality information is performed using input sequences o₀, o₁, o₂, . . . , o_{O-1} (S1350). Output bit sequences for channel coding for channel quality information are q₀, q₁, q₂, q₃, . . . , q_{Q}_{_{CQI}}₋₁. The channel coding scheme is varied depending on bits of channel quality information. Also, if the channel quality information is more than 11 bits, CRC 8 bits are added thereto. Q_{CQI} represents a total of coded bits. In order to adjust a length of bit sequence to Q_{CQI}, the coded channel quality information may be rate-matched. Q_{CQI}=Q′_{CQI}×Qₘ, Q′_{CQI} is the number of coded symbols for CQI, and Qₘ is a modulation order. Qₘ is set equally to UL-SCH data.

Channel coding of RI is performed using input sequence [o₀^{RI}] or [o₀^{RI} o₁^{RI}] (S1360). [o₀^{RI}] and [o₀^{RI} o₁^{RI}] respectively mean 1-bit RI and 2-bit RI.

In case of 1-bit RI, repetition coding is used. In case of 2-bit RI, simplex code (3, 2) is used, and encoded data may be repeated cyclically. Also, RI of 3 bits to 11 bits is coded using RM code (32, O) used for an uplink shared channel, and RI of 12 bits or more is divided into two groups by using a double RM structure and then each group is coded using RM code (32, O). The output bit sequences q₀^{RI}, q₁^{RI}, q₂^{RI}, . . . , q_{Q}_{_{RI}}₋₁^{RI} are obtained by combination of coded RI block(s). Q_{RI} represents a total number of coded bits. In order to adjust a length of the coded RI to Q_{RI}, the coded RI block which is finally combined may be a part (that is, rate matching). Q_{RI}=Q′_{RI}×Qₘ, Q′_{RI} is the number of coded symbols for RI, and Qₘ is a modulation order. Qₘ is set equally to UL-SCH data.

Channel coding of HARQ-ACK is performed using input sequence [o₀^{ACK}], [o₀^{ACK} o₁^{ACK}] or [o₀^{ACK} o₁^{ACK} . . . o_{O}_{^{ACK}}₋₁^{ACK}] of step S1370. [o₀^{ACK}] and [o₀^{ACK} o₁^{ACK}] respectively mean 1-bit HARQ-ACK and 2-bit HARQ-ACK. Also, [o₀^{ACK} o₁^{ACK} . . . o_{O}_{^{ACK}}₋₁^{ACK}] means HARQ-ACK configured by information of two bits or more (that is, O^{ACK}>2). ACK is coded to 1, and NACK is coded to 0. In case of 1-bit HARQ-ACK, repetition coding is used. In case of 2-bit HARQ-ACK, simplex code (3, 2) is used, and encoded data may be repeated cyclically. Also, HARQ-ACK of 3 bits to 11 bits is coded using RM code (32, O) used for an uplink shared channel, and HARQ-ACK of 12 bits or more is divided into two groups by using a double RM structure and then each group is coded using RM code (32, O). Q_{ACK} represents a total number of coded bits. The bit sequences q₀^{ACK}, q₁^{ACK}, q₂^{ACK}, . . . , q_{Q}_{_{ACK}}₋₁^{ACK} are obtained by combination of coded HARQ-ACK block(s). In order to adjust a length of the bit sequence to Q_{ACK}, the coded HARQ-ACK block which is finally combined may be a part (that is, rate matching). Q_{ACK}=Q′_{ACK}×Qₘ, Q′_{ACK} is the number of coded symbols for HARQ-ACK, and Qₘ is a modulation order. Qₘ is set equally to UL-SCH data.

The inputs for data/control multiplexing blocks are f₀, f₁, f₂, f₃, . . . , f_{G-1}, which mean the coded UL-SCH bits, and q₀, q₁, q₂, q₃, . . . , q_{Q}_{_{CQI}}₋₁, which mean the coded CQI/PMI bits (S1380). The outputs of the data/control multiplexing blocks are g₀, g₁, g₂, g₃, . . . , g_{H′-1}. gᵢ is a column vector of length Qₘ (i=0 . . . , H′−1) H′=H/Qₘ, H=(G+Q_{CQI}), and H is a total number of coded bits allocated for UL-SCH data and CQI/PMI.

Input of a channel leaver is performed for the outputs g₀, g₁, g₂, g₃, . . . , g_{H′-1} of the data/control multiplexing blocks, coded rank indicators q₀^{RI}, q₁^{RI}, q₂^{RI}, . . . , q_{Q′}_{_{RI}}₋₁^{RI} and coded HARQ-ACK q₀^{ACK}, q₁^{ACK}, q₂^{ACK}, . . . , q_{Q′}_{_{ACK}}₋₁^{ACK} (S1390). gᵢ is a column vector of length Qₘ for CQI/PMI, and i=0, . . . , H′−1 (H′=H/Qₘ). qᵢ^{ACK} is a column vector of length Qₘ for ACK/NACK, and i=0, . . . , Q′_{ACK}−1 (Q′_{ACK}=Q_{ACK}/Qₘ). qᵢ^{RI} is a column vector of length Qₘ for RI, and i=0, . . . , Q′_{RI}−1 (Q′_{RI}=Q_{RI}/Qₘ).

The channel interleaver multiplexes control information and UL-SCH data for PUSCH transmission. In more detail, the channel interleaver maps control information and UL-SCH data into a channel interleaver matrix corresponding to the PUSCH resource.

After channel interleaving is performed, bit sequences h₀, h₁, h₂, . . . , h_{H+Q}_{_{RI}}₋₁ read from the channel interleaver matrix through column-by-column are output. The read bit sequences are mapped on a resource grid. H″=H′+Q′_{RI} number of modulation symbols are transmitted through a subframe.

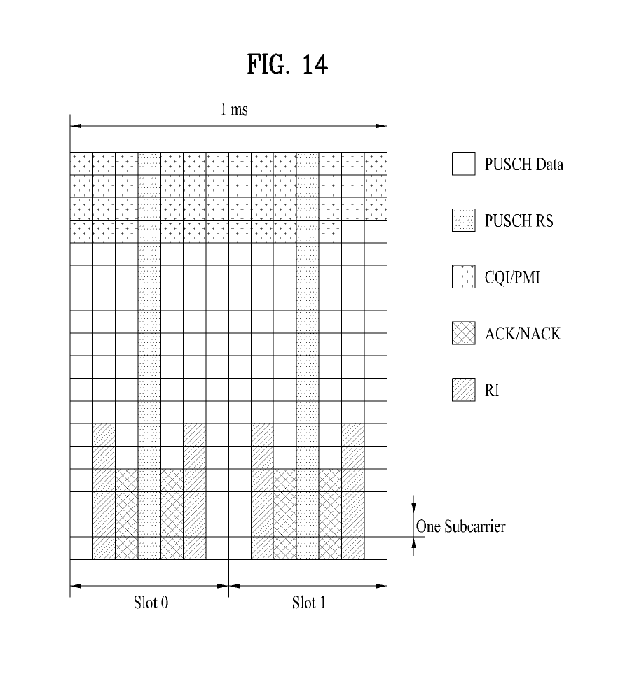

FIG. 14 is a diagram illustrating an example of a method for multiplexing control information and UL-SCH data on a PUSCH.

If the user equipment intends to transmit control information for the subframe where PUSCH transmission is allocated, the user equipment multiplexes the uplink control information (UCI) and the UL-SCH data prior to DFT-spreading. The uplink control information (UCI) includes at least one of CQI/PMI, HARQ ACK/NACK and RI.

The number of REs used for transmission of CQI/PMI, ACK/NACK and RI is based on modulation and coding scheme (MCS) and offset values (Δ_{offset}^{CQI}, Δ_{offset}^{HARQ-ACK}, Δ_{offset}^{RI}) allocated for PUSCH transmission. The offset values allow different coding rates in accordance with the control information and are set semi-statically by higher layer (for example, RRC) signaling. The UL-SCH data and the control information are not mapped into the same RE. The control information is mapped to exist in two slots of the subframe. Since the base station may previously know that the control information will be transmitted through the PUSCH, it may easily demultiplex the control information and data packet.

Referring to FIG. 14, CQI and/or PMI(CQI/PMI) resources are located at a start part of UL-SCH data resources, and are sequentially mapped into all the SC-FDMA symbols on one subcarrier and then mapped on next subcarrier. CQI/PMI are mapped from the left to the right within the subcarrier, that is, to increase the SC-FDMA symbol index. The PUSCH data (UL-SCH data) are rate-matched considering the CQI/PMI resources (that is, the number of coded symbols). The same modulation order as that of the UL-SCH data is used for the CQI/PMI.

For example, if CQI/PMI information size (payload size) is small (for example, less than 11 bits), (32, k) block code is used for CQI/PMI information similarly to PUCCH transmission, and encoded data may be repeated cyclically. If the CQI/PMI information size is small, CRC is not used.

If the CQI/PMI information size is great (for example, more than 11 bits), 8-bit CRC is added, and channel coding and rate matching are performed using a tail-biting convolutional code. The ACK/NACK is inserted into a part of SC-FDMA resources into which the UL-SCH data are mapped, through puncturing. The ACK/NACK is located next to the RS, and is filled from the bottom to the top within the corresponding SC-FDMA symbol, that is, to increase subcarrier index.

In case of the normal CP, SC-FDMA symbols for ACK/NACK are located at SC-FDMA symbols #2/#4 in each slot as shown in FIG. 14. The coded RI symbol is located (that is, symbols #1/#5) next to the symbols for ACK/NACK regardless of the fact that the ACK/NACK is actually transmitted for the subframe. At this time, the ACK/NACK, the RI and the CQI/PMI are coded independently.

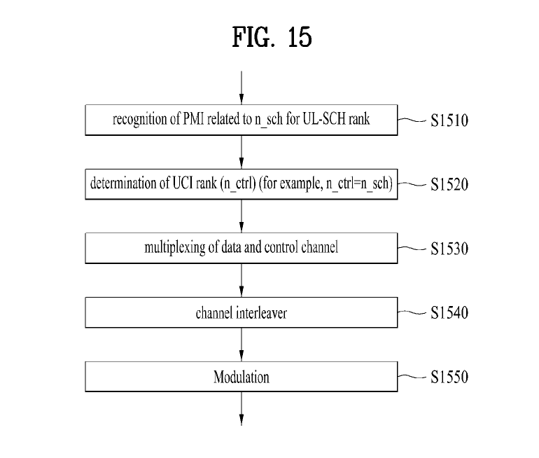

FIG. 15 is a diagram illustrating multiplexing of control information and UL-SCH data in a multiple input multiple output (MIMO) system.

Referring to FIG. 15, the user equipment identifies a rank (n_sch) for UL-SCH (data part) and PMI related to the rank from scheduling information for PUSCH transmission (S1510). Also, the user equipment determines a rank (n_ctrl) for the UCI (S1520). The rank of the UCI may be set, but not limited to, equally to the rank of the UL-SCH (n_ctrl=n_sch). Afterwards, multiplexing of data and a control channel is performed (S1530). Afterwards, the channel interleaver performs time-first mapping of data/CQI and maps ACK/NACK/RI by puncturing surroundings of DM-RS (S1540). Then, modulation of the data and the control channel is performed in accordance with MCS table (S1550). Examples of the modulation scheme include QPSK, 16QAM, and 64QAM. The order/location of the modulation blocks may be varied (for example, prior to multiplexing of data and control channel).

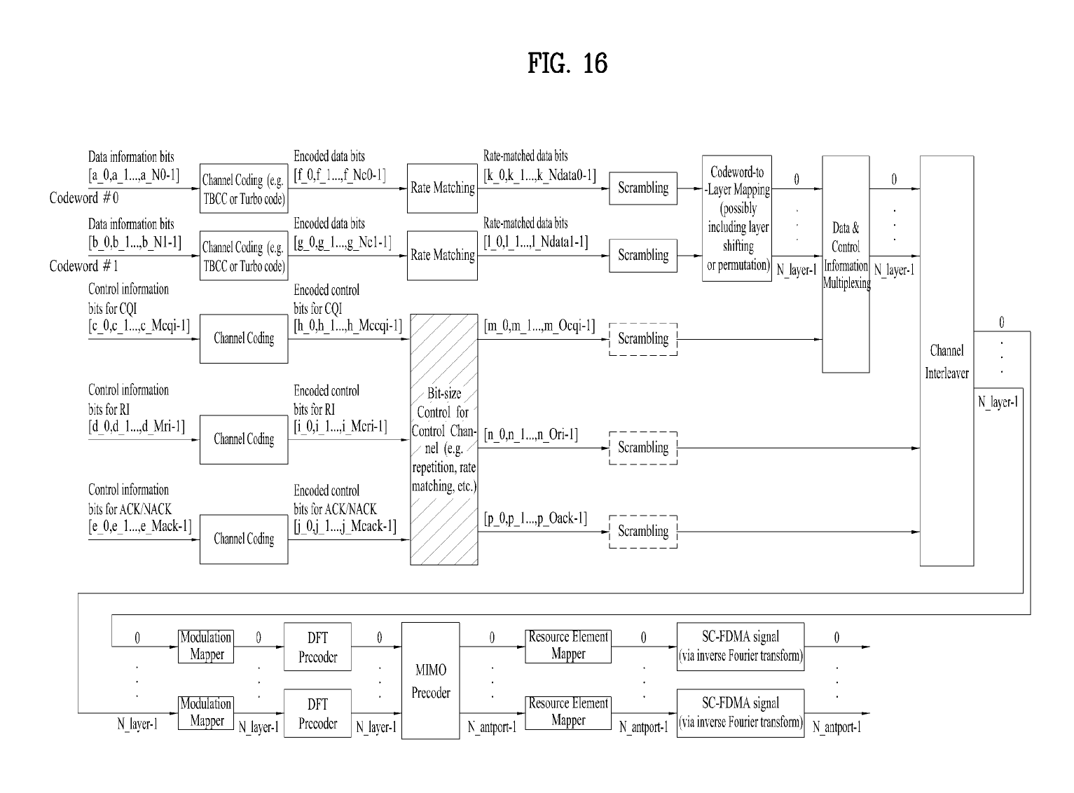

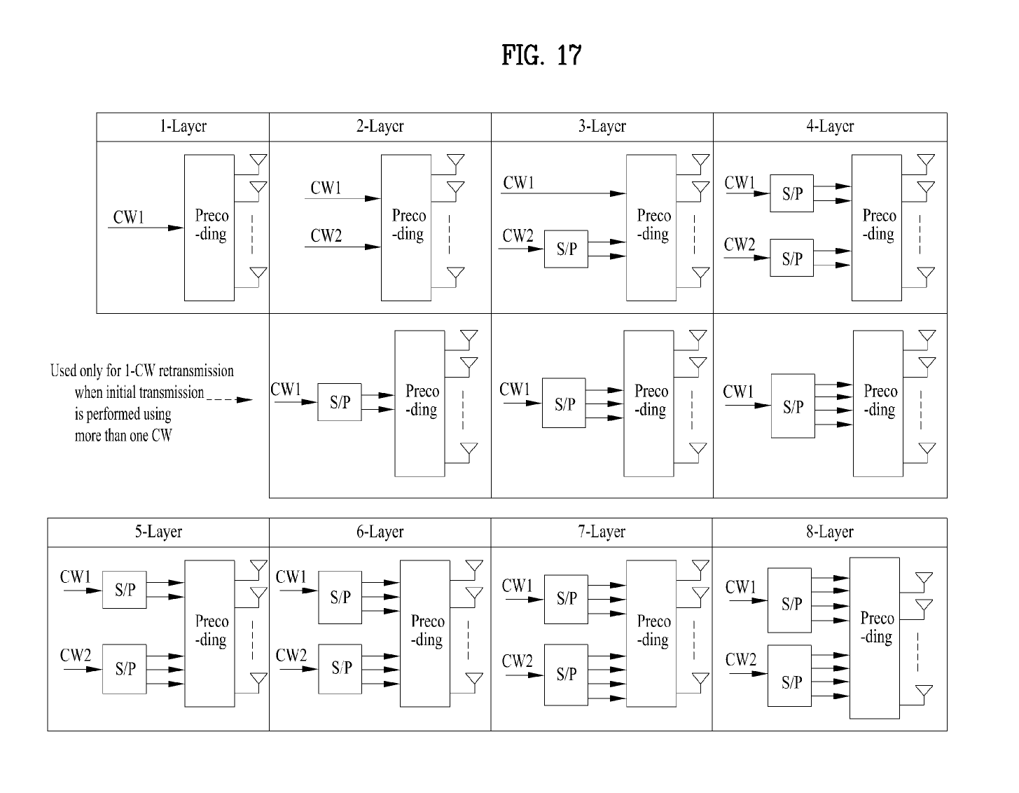

FIG. 16 and FIG. 17 are diagrams illustrating a method of multiplexing a plurality of UL-SCH transport blocks included in a user equipment and uplink control information in the user equipment and transmitting the multiplexed data in accordance with one embodiment of the present invention.

Although it is assumed that two codewords are transmitted in FIG. 16 and FIG. 17, FIG. 16 and FIG. 17 may be applied to a case where one codeword or three or more codewards are transmitted. The codeword and the transport block correspond to each other, and are used to refer to the same in this specification. Since the basic multiplexing procedure is the same as/similar to the description of FIG. 13 and FIG. 14, multiplexing related to MIMO will be described mainly.

Referring to FIG. 15 and FIG. 17, after channel coding, the respective codewords are rate-matched in accordance with a given MCS table. Then, the encoded bits are scrambled cell-specifically, UL-specifically, UE-specifically, and codeword-specifically. Afterwards, codeword-to-layer mapping is performed for the scrambled codewords. The codeword-to-layer mapping may include action such as layer shifting (or permutation), for example. An example of the codeword-to-layer mapping is shown in FIG. 17. The later operations are the same as/similar to the aforementioned operations except that the operations are performed in a unit of layer.

However, in case of MIMO, MIMO precoding is applied to the output of DFT precoding. MIMO precoding serves to map/distribute layers (or virtual antenna) into physical antennas. MIMO precoding is performed using a precoding matrix, and may be performed in the order/location different from those of FIG. 17.

The UCI (for example, CQI, PMI, RI, ACK/NACK, etc.) may be channel-coded independently in accordance with a given scheme. The number of encoded bits is controlled by a bit-size controller (hatching block). The bit-size controller may be included in the channel coding block. The bit-size controller may be operated as follows.

1. RI (n_rank_pusch) for PUSCH is identified.

2. n_rank_ctrl=n_rank_pusch is set such that the number of bits (n_bit_ctrl) for a control channel is extended to n_ext_ctrl=n_rank_ctrl*n_bit_ctrl.

A. The bit-size control may extend the bits of the control channel through simple repetition. For example, supposing that the bits of the control channel are [a0 a1 a2 a3] (that is, n_bit_ctrl=4) and n_rank_pusch=2, the extended control channel bits may be [a0 a1 a2 a3 a0 a1 a2 a3](that is, n_ext_ctrl=8).

B. The bit-size controller may extend the bits of the control channel on the basis of a concept of a cyclic buffer such that the bits of the control channel may reach n_ext_ctrl.

If the bit-size controller and the channel coding block are incorporated into one (for example, in case of CQI/PMI control channel), encoded bits may be generated through channel coding and rate matching may be performed in accordance with the existing LTE rule.

In addition to the bit-size controller, much more randomization may be provided to the layer by bit-level interleaving.

In the case that the rank of the control channel is limited equally to the rank of the data channel, it is advantageous in view of signaling overhead. If the rank of the data is different from that of the control channel, it is required to additionally signal PMI for the control channel. Also, if the same RI is used for the data and the control channel, it is advantageous to simplify a multiplexing chain. Accordingly, although an effective rank of the control channel is 1, a rank actually used to transmit the control channel may be n_rank_pusch. In view of reception, after a MIMO decoder is applied to each layer, each LLR output is accumulated using maximum ratio combining (MRC).

CQI/PMI channel and data part of two codewords are multiplexed by a data and control multiplexing block. Afterwards, the channel interleaver performs time-first mapping, and allows HARQ ACK/NACK information to exist in both slots of the subframe and to be mapped into surrounding resources of an uplink demodulation reference signal.

Afterwards, modulation, DFT precoding, MIMO precoding and resource element (RE) mapping are performed for each of the layers. At this time, layer specific scrambling may be added to ACK/NACK and RI which are distributed into all the layers. Also, piggyback may be performed for the UCI of the CQI/PMI by selecting a specific codeword.

2. Multi-Carrier Aggregation Environment

A communication environment considered by the embodiments of the present invention includes a multi-carrier environment. In other words, a multi-carrier system or carrier aggregation system used in the present invention means a system that one or more carriers having a bandwidth smaller than a target bandwidth are aggregated when a target wideband is configured, to support a wideband.

In the present invention, multi-carrier means aggregation of carriers (or carrier aggregation). At this time, carrier aggregation means aggregation between non-neighboring carriers as well as aggregation between neighboring carriers. Also, carrier aggregation may be used to refer to bandwidth aggregation.

Multi-carrier (that is, carrier aggregation) configured by aggregation of two or more component carriers (CC) aims to support a bandwidth of 100 MHz in the LTE-A system. When one or more carriers having a bandwidth smaller than a target bandwidth are aggregated, a bandwidth of the aggregated carriers may be limited to a bandwidth used in the existing system to maintain backward compatibility with the existing IMT system.

For example, the 3GPP LTE system supports bandwidths of {1.4, 3, 5, 10, 15, 20} MHz, and the 3GPP LTE_advanced system (that is, LTE_A) may support a bandwidth greater than 20 MHz using the above bandwidths supported by the LTE system. Also, the multi-carrier system used in the present invention may support carrier aggregation by defining a new bandwidth regardless of the bandwidth used in the existing system.

The LTE-A system uses a concept of cell to manage radio resources. The cell is defined by combination of downlink resources and uplink resources, wherein the uplink resources may be defined selectively. Accordingly, the cell may be configured by downlink resources only, or may be configured by downlink resources and uplink resources. If multi-carrier (that is, carrier aggregation) is supported, linkage between carrier frequency (or DL CC) of the downlink resources and carrier frequency (or UL CC) of the uplink resources may be indicated by system information (SIB).

The cell used in the LTE-A system includes a primary cell (PCell) and a secondary cell (SCell). The P cell may mean a cell operated on the primary frequency (or primary CC), and the S cell may mean a cell operated on the secondary frequency (or secondary CC). However, a single P cell may be allocated to a specific user equipment and one or more S cells may be allocated to the specific user equipment.

The P cell is used such that the user equipment performs an initial connection establishment procedure or connection re-establishment procedure. The P cell may refer to a cell indicated during a handover procedure. The S cell may be configured after RRC connection is established, and may be used to provide an additional radio resource.

The P cell and the S cell may be used as serving cells. Although the user equipment is in RRC-CONNECTED state, if it is not set by carrier aggregation or does not support carrier aggregation, a single serving cell configured by the P cell only exists. On the other hand, if the user equipment is in the RRC-CONNECTED state and is set by carrier aggregation, one or more serving cells may exist, wherein the serving cells may include a P cell and one or more S cells.

After an initial security activity procedure starts, the E-UTRAN may configure a network that includes one or more S cells in addition to a P cell initially configured during a connection establishment procedure. In the multi-carrier environment, the P cell and the S cell may be operated as component carriers, respectively. In other words, carrier matching may be understood by aggregation of the P cell and one or more S cells. In the following embodiment, the primary component carrier (PCC) may be used to refer to the P cell, and the secondary component carrier (SCC) may be used to refer to the S cell.

3. Hybrid Automatic Retransmit request (HARQ) Scheme

Examples of retransmission schemes may include an HARQ scheme and an ARQ scheme. Generally, the ARQ scheme senses loss of a frame in a link layer and performs a function for retransmission. The ARQ scheme is widely used in a data link which is a second layer of a network protocol, and is considerably advantageous when a channel status is temporarily poor.

The HARQ scheme is used in a state that a radio channel status is always poor, and means that a forward error correction (FEC) scheme is applied to the ARQ scheme. For example, in the HARQ scheme, information having an error is stored in a buffer by a receiving side and then combined with retransmitted information, whereby the FEC scheme is applied to the combined information. The HARQ scheme is widely used in a physical layer. The HARQ scheme may be divided into four schemes as follows.

According to the first scheme of the HARQ scheme, the receiving side first applies the FEC scheme by identifying an error detection code included in the data. If there is any error in a packet, the receiving side requests the transmitting side of retransmission. The receiving side disregards the packet having an error, and the transmitting side a packet for retransmission by using the same FEC code as that of the disregarded packet.

The second scheme of the HARQ scheme will be referred to as an incremental redundancy (IR) ARQ scheme. According to the second scheme of the HARQ scheme, the receiving side stores an initially transmitted packet in a buffer without disregarding the packet and combines the initially transmitted packet with retransmitted redundancy bits. The transmitting side retransmits parity bits only except for data bits during retransmission. The parity bits transmitted from the transmitting side are varied per retransmission.

The third scheme of the HARQ scheme corresponds to a specific scheme of the second scheme. Each packet is self-decodable. The transmitting side configures a packet having an error and a packet having all data and retransmits the packets. The third scheme of the HARQ scheme enables decoding exacter than the second scheme of the HARQ scheme but its efficiency is deteriorated in view of coding gain.

The fourth scheme of the HARQ scheme corresponds to the scheme to which a combining function of data initially received and stored by the receiving side and retransmitted data is added. The HARQ schemed based on the fourth scheme may be referred to as a metric combining scheme or a chase combining scheme. According to the fourth scheme of the HARQ scheme, gain is obtained in view of a signal to interference noise ratio (SINR), and same parity bits of the retransmitted data are always used.

4. Method for Transmitting Uplink Control Information

The related art discloses methods for transmitting uplink control information (UCI) from a user equipment through one transport block (TB) having one layer. However, SU-MIMO is used under the multi-carrier aggregation environment, wherein the user equipment may transmit and receive data through two or more layers and use two or more transport blocks. Accordingly, unlike the related art method for transmitting uplink data, a new method for transmitting uplink data will be required.

Hereinafter, various methods for transmitting uplink control information (UCI) from a user equipment in a multi-carrier environment in accordance with the embodiments of the present invention will be described. Also, methods for selecting transport blocks to multiplex UCI into retransmitted data during uplink data retransmission in an SU-MIMO environment will be described in detail.

Although the transport block (TB) is technically different from a code word (CW), since the TB and the CW are equally mapped in most cases of the LTE-A system, it is assumed that the TB and the CW may be used to refer to the same thing in the embodiments of the present invention.

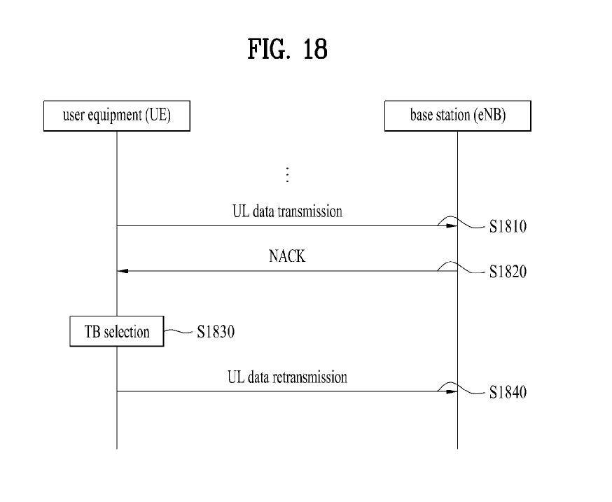

FIG. 18 is a diagram illustrating an example of a method for transmitting uplink control information during uplink data transmission in accordance with one embodiment of the present invention.

Referring to FIG. 18, the user equipment (UE) may transmit uplink data to the base station (eNB) (S1810).

If the base station discovers an error in the uplink data received at the step S1810 or fails to normally receive the uplink data, it may transmit a non-acknowledgement (NACK) signal to the user equipment (S1820).

The user equipment that has received the NACK signal retransmits the uplink data which are previously transmitted. At this time, the user equipment may select the transport block (TB) for transmitting UCI to the base station during retransmission. In other words, in the SU-MIMO environment, the user equipment may use two or more TBs to transmit the UCI, and may select whether to transmit the UCI to what TB depending on the retransmission status (S1830).

The user equipment may transmit the UCI by using the selected TB at the step S1830. In other words, the user equipment may use two or more TBs to retransmit the uplink data, and may multiplex the UCI into the TB selected at the step S1830. Accordingly, the user equipment may retransmit the UL data multiplexed with the UCI to the base station (S1840).

Although retransmission of the UL data has been only described at the step S1840, the user equipment may transmit data through one or more TBs in the multi-carrier aggregation environment. Accordingly, the user equipment may transmit retransmission data by using a part of the TBs and at the same time transmit new UL data to the other TB.

Hereinafter, various methods for selecting a TB for transmitting the UCI at the step S1830 will be described. Also, in the embodiments of the present invention, although the user equipment may transmit uplink data and/or uplink control information by using two or more TBs under the SU-MIMO environment, for convenience of description, the case where two TBs are used will be described.

4.1 TB Selection Method—1

If the user equipment multiplexes UCI and PUSCH data by using a plurality of layers in a carrier aggregation (CA) environment (that is, multi-CC environment), the UCI may repeatedly be mapped into all or some of the layers.

For example, if the user equipment multiplexes the UCI and uplink data into PUSCH in an SU-MIMO environment of the LTE-A system, HARQ-ACK information and RI information are repeatedly transmitted to all the layers which are transmitted, and CQI is multiplexed into all the layers that belong to one TB.

At this time, retransmission data may be allocated to one TB, and initially transmitted data may be allocated to the other TB. At this time, the user equipment may select the TB (or CW) to which the retransmission data are allocated, as the TB for CQI transmission.

Generally, the receiving side (for example, base station) decodes data by information obtained from newly received data and retransmitted UL data in case of retransmission. Accordingly, in case of retransmitted data, required quality of transmission may be lower than that of initial transmission.

For example, in case of IR based HARQ, the user equipment transmits new parity symbols (or bits) for the data which are previously transmitted, without retransmitting full data, whereby the amount of the retransmitted data is very smaller than that of initial transmission (see, section 3. HARQ Scheme). Accordingly, in case of IR, since a transport block size (TBS) of a transport block (TB) (or CW) for the retransmitted data is very smaller than that of initial transmission, the number of REs allocated to CQI may be set in the corresponding TB within the sufficiently great range.

Accordingly, if retransmission data are transmitted to one TB only, the user equipment may allocate more resource elements (REs) to CQI within the corresponding TB by transmitting CQI through the TB for retransmitting UL data. As a result, robustness of CQI transmission may be increased, and more resource elements (REs) may be allocated to the TB that transmits initial data, whereby throughput of data transmission may be increased. Accordingly, the user equipment may multiplex CQI into the TB to which the retransmission data are allocated, and may transmit the multiplexed data to the base station.

4.2 TB Selection Method—2

If the user equipment multiplexes UCI and PUSCH data by using a plurality of layers in a carrier aggregation (CA) environment (that is, multi-CC environment), the UCI may repeatedly be mapped into all or some of the layers.

For example, if the user equipment multiplexes the UCI and uplink data into PUSCH in an SU-MIMO environment of the LTE-A system, HARQ-ACK information and RI information are repeatedly copied to all the layers that belong to all the TBs, and CQI is multiplexed into all the layers that belong to one TB.

At this time, two TBs may be used for retransmission of data. In this case, the user equipment may select (1) the TB of which the number of retransmission times is great, (2) the TB having high MCS level, or (3) the TB having a great TBS, as the TB for CQI transmission.

The TB of which the number of retransmission times is great may be interpreted that there are many kinds of information of the receiving side (for example, base station) for data to be retransmitted to the receiving side. In this case, it is likely to successfully decode data retransmitted from the receiving side even by information smaller than the data of which the number of retransmission times is high. Accordingly, even though less data are allocated to the TB of which the number of retransmission times is high, since it is likely that the receiving side decodes retransmission data, the user equipment may allocate more REs for CQI to the corresponding TB. Accordingly, it is advantageous in view of robustness of CQI and data throughput in that the user equipment transmits CQI through the TB of which the number of retransmission times is high.

However, if two TBs are used for retransmission, since the receiving side has failed to decode data, the same amount of information may be newly transmitted from the transmitting side (for example, user equipment) regardless of the number of retransmission times for the two TBs. In this case, the user equipment determines the two TBs equally to the case of initial transmission, whereby the user equipment may preferably transmit CQI by selecting the TB having high MCS level or great TBS.

4.3 TB Selection Method—3

If the user equipment multiplexes UCI and PUSCH data by using a plurality of layers in a carrier aggregation (CA) environment (that is, multi-CC environment), the UCI may repeatedly be mapped into all or some of the layers.

For example, if the user equipment multiplexes the UCI and uplink data into PUSCH in an SU-MIMO environment of the LTE-A system, HARQ-ACK and RI are repeatedly copied to all the layers that belong to all the TBs, and CQI is multiplexed into all the layers that belong to one TB.

At this time, two TBs may be used for retransmission of data, and the same number of retransmission times may be applied to the two TBs. In this case, the user equipment may select (1) the TB having high MCS level, or (3) the TB having a great TBS, as the TB (or CW) for CQI transmission.

For example, in case of CC based HARQ that transmits the same data as that of initial transmission (see, section 3. HARQ Scheme), even though a channel status of the TB is not better than that of the other TB (or CW), the user equipment may allocate more REs to CQI by increasing a CQI beta offset value, whereby robustness of CQI transmission may be enhanced.

In the aforementioned embodiments of the present invention, the transport block (TB) for transmitting UCI (for example, CQI) has been selected by the user equipment. However, the base station may select a specific TB by considering performance of the user equipment, channel status, etc., whereby UCI may be transmitted through the TB selected by the base station. In this case, the base station may provide the user equipment with information on the selected TB through PDCCH signal or higher layer signaling (for example, RRC signaling) during NACK signal transmission.

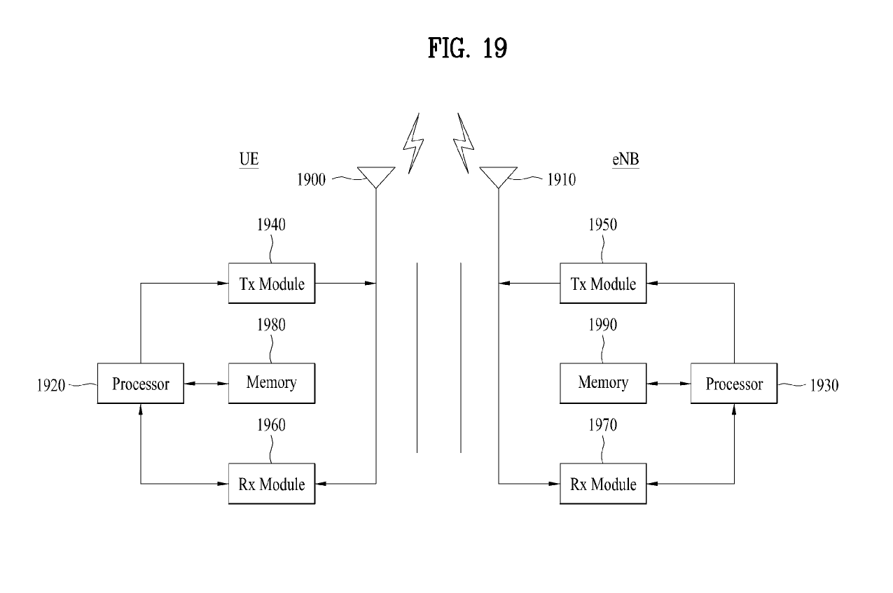

FIG. 19 is a diagram illustrating a base station and a user equipment through which the embodiments of the present invention described with reference to FIG. 1 to FIG. 18 may be carried out.

The user equipment may be operated as a transmitter on an uplink and as a receiver on a downlink. Also, the base station may be operated as a receiver on the uplink and as a transmitter on the downlink.

In other words, each of the user equipment and the base station may include a transmission (Tx) module 1940, 1950 and a reception (Rx) module 1960, 1970 to control transmission and reception of information, data and/or message, and an antenna 1900, 1910 for transmitting and receiving information, data and/or message. Also, each of the user equipment and the base station may include a processor 1920, 1930 for performing the aforementioned embodiments of the present invention and a memory 1980, 1990 for temporarily or continuously storing a processing procedure of the processor. Also, the user equipment and the base station of FIG. 19 may further include one or more of an LTE module for supporting the LTE system and the LTE-A system, and a low power radio frequency (RF)/intermediate frequency (IF) module.

The Tx module and the Rx module included in the user equipment and the base station may perform a packet modulation and demodulation function for data transmission, a quick packet channel coding function, an orthogonal frequency division multiple access (OFDMA) packet scheduling, time division duplex (TDD) packet scheduling and/or channel multiplexing function.

The device described in FIG. 19 is the means for implementing the methods described with reference to FIG. 1 to FIG. 18. The embodiments of the present invention may be performed using the modules and functions of the user equipment and the base station. Also, the device described in FIG. 19 may further include the modules or elements of FIG. 2 to FIG. 4. Preferably, the processor may include the modules or elements of FIG. 2 to FIG. 4.

The processor of the user equipment may receive a PDCCH signal by monitoring a search space. In particular, the LTE-A user equipment may receive a PDCCH without blocking for a PDCCH signal with another LTE user equipment by performing blind decoding (BD) for an extended CSS.

In the meantime, in the present invention, examples of the user equipment may include a personal digital assistant (PDA), a cellular phone, a personal communication service (PCS) phone, a global system for mobile (GSM) phone, a wideband CDMA (WCDMA) phone, a mobile broadband system (MBS) phone, a hand-held PC, a notebook PC, a smart phone, and a multi mode-multi band (MM-MB) terminal.

In this case, the smart phone is a terminal provided with advantages of a mobile communication terminal and a personal digital assistant (PDA). The smart phone may mean a terminal in which a schedule management function of the PDA and data communication functions of facsimile transmission/reception, internet access, etc. are integrated on a mobile communication terminal. Also, the multimode-multiband terminal means a terminal having a built-in multi-MODEM chip to be operable in a portable internet system and other mobile communication systems (e.g., CDMA (code division multiple access) 2000 system, WCDMA (wideband CDMA) system, etc.).

The embodiments according to the present invention may be implemented by various means, for example, hardware, firmware, software, or their combination.

If the embodiment according to the present invention is implemented by hardware, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method according to the embodiments of the present invention may be implemented by a type of a module, a procedure, or a function, which performs functions or operations described as above. For example, a software code may be stored in the memory unit 1980, 1990 and then may be driven by the processor 1920, 1930. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

The aforementioned embodiments of the present invention may be applied to various wireless access systems. Examples of the various wireless access systems include 3GPP LTE system, 3GPP2 and/or IEEE 802.xx (Institute of Electrical and Electronic Engineers 802) system. The embodiments of the present invention may be applied to all the technical fields based on the various wireless access systems as well as the various wireless access systems.

1. A method for transmitting uplink control information (UCI) from a user equipment in a wireless access system, the method comprising:
transmitting uplink data to a base station;
receiving a non-acknowledgement (NACK) signal for the uplink data from the base station;
selecting a transport block for transmitting the UCI, during retransmission of the uplink data in accordance with the NACK signal; and
retransmitting uplink data including the UCI,
wherein the user equipment transmits the UCI to the base station by using the selected transport block.

2. The method according to claim 1, wherein the selected transport block is a second transport block, when a first transport block is used to transmit new uplink data and the second transport block is used to retransmit the uplink data.

3. The method according to claim 1, wherein the selected transport block is a transport block having a greater number of retransmission times, when one or more transport blocks are used to retransmit the uplink data.

4. The method according to claim 1, wherein the selected transport block is a transport block having a high modulation and coding scheme (MCS) level, when one or more transport blocks are used to retransmit the uplink data.

5. The method according to claim 1, wherein the selected transport block is a transport block having a greatest transport block size, when one or more transport blocks are used to retransmit the uplink data.

6. The method according to claim 2, wherein the UCI is a channel quality indicator (CQI).

7. A method for receiving uplink control information (UCI) by a base station in a wireless access system, the method comprising:
receiving uplink data from a user equipment;
transmitting a non-acknowledgement (NACK) signal for the uplink data to the user equipment; and
receiving the uplink data retransmitted in accordance with the NACK signal,
wherein the UCI is included in the retransmitted uplink data, and
a transport block, which includes the UCI, is selected considering one or more of a number of retransmission times, a modulation and coding scheme (MCS) level, and a transport block size.

8. The method according to claim 7, wherein the selected transport block is the second transport block, when a first transport block is used to transmit new uplink data and the second transport block is used to retransmit the uplink data.

9. The method according to claim 7, wherein the selected transport block is a transport block having a greater number of retransmission times, when one or more transport blocks are used to retransmit the uplink data.

10. The method according to claim 7, wherein the selected transport block is a transport block having a high modulation and coding scheme (MCS) level, when one or more transport blocks are used to retransmit the uplink data.

11. The method according to claim 7, wherein the selected transport block is a transport block having the greatest transport block size, when one or more transport blocks are used to retransmit the uplink data.

12. The method according to claim 8, wherein the UCI is a channel quality indicator (CQI).
